(19) United States
(12) Patent Application Publication
(10) Pub. No.: US 2007/0266031 A1
(43) Pub. Date: Nov. 15, 2007

(54) Identifying content

(76) Inventors: J. Trent Adams, Framingham, MA (US); James M. Butler, Tyngsboro, MA (US)

Correspondence Address: FISH & RICHARDSON PC, P.O. BOX 1022, MINNEAPOLIS, MN, 55440-1022, US

(21) Appl. No.: 11/490,460

(22) Filed: Jul. 20, 2006

Related U.S. Application Data
(60) Provisional application No. 60/800,579, filed on May 15, 2006.

(51) Int. Cl. G06F 17/30

(52) U.S. Cl. 707/10

(57) ABSTRACT

Communicating with a client over a network includes accepting from the client first data arranged in a data structure that includes data values that correspond to preferences associated with a plurality of characteristics of content, and second data that includes interaction information that characterizes one or more user interactions with the client. Communicating with the client further includes modifying the first data according to the interaction information; and providing to the client the modified data.

### CROSS-REFERENCE TO RELATED APPLICATIONS

This application claims the benefit of U.S. Provisional Application Ser. No. 60/800,579, filed on May 15, 2006, incorporated herein by reference.

### BACKGROUND

The invention relates to identifying content.

There are a variety of types of content available from a variety of sources that can be accessed over a network and delivered over a communication channel to a client. The client can be, for example, a device such as a computer (e.g., desktop, laptop, or handheld), a phone, or a media player, or can be integrated into a person's environment (e.g., a car, a home, or clothing). Different clients may have different capabilities. For example, some clients may not be able to present all potential types of multimedia content that may be available (e.g., text, images, audio, and/or video), or may not be able to process all types of content formats (e.g., file formats, compression formats, proprietary application documents).

Various approaches exist for identifying and/or delivering content to a client. In some cases, a user enters a query at the client, and a search engine provides links to content matching the query according to search criteria. In some cases, a user selects specific content from a guide (e.g., a web portal) presented to the user on the client (e.g., in a web browser running on the client). Some content delivery systems do not require an explicit user request or query, but rather push content to the client based on predetermined user profiles or preferences.

Some techniques for providing content to users store information about the user such as preferences at the server side (e.g., in a database accessible to the server). Some techniques store information at the client side using, for example, Hypertext Transfer Protocol (HTTP) cookies. An application running on a server can send an HTTP cookie to a client application (e.g., a web browser) to be stored at the client for later retrieval. The client sends the cookie back to the server that set the cookie when the web browser later accesses that server. The cookie can be used, for example, to authenticate a user, or to maintain user preferences associated with the server, or other state information (e.g., the state of a “shopping cart”). The server can provide a new value for a previously stored cookie, and the client web browser replaces the previous value with the new value.

### SUMMARY

In one aspect, in general, the invention features a method for communicating with a client over a network. The method comprises accepting from the client first data arranged in a data structure that includes data values that correspond to preferences associated with a plurality of characteristics of content, and second data that includes interaction information that characterizes one or more user interactions with the client. The method further comprises modifying the first data according to the interaction information; and providing to the client the modified data.

Aspects of the invention can include one or more of the following features.

The method further comprises identifying content corresponding to at least one of the characteristics based on at least one of the data values; and providing to the client a plurality of content identifiers, each identifying a location in the network of a portion of the identified content.

The second data includes a content request.

Identifying content corresponding to at least one of the characteristics based on at least one of the data values comprises selecting content identifiers from a catalog of content based on at least one of the data values, where content associated with each of the content identifiers corresponds to the content request.

Selecting content identifiers from the catalog of content comprises selecting a first content identifier associated with a content description in the catalog that directly matches the content request, and corresponds to at least one of the data values

Selecting content identifiers from the catalog of content comprises selecting a second content identifier associated with a content description in the catalog that is related to the content description associated with the first content identifier, and corresponds to at least one of the data values.

The second data includes information that indicates device characteristics of the client.

Identifying content further comprises matching the device characteristics included in the second data to device characteristics included in the second data.

The first data further includes data values that correspond to preferences associated with one or more samples of content.

The first data further includes data values that correspond to preferences associated with one or more media types.

At least some of the data values are modified by respective weighting factors that indicate a relative importance of different preferences to a user.

The interaction information comprises data characterizing one or more user interactions with the client associated with content retrieved according to content identifiers provided to the client before the first data was modified.

The one or more user interactions with the client comprise rating content according to a characteristic.

Modifying the first data according to the interaction information comprises adding a data value to the data structure indicating a preference associated with the characteristic according to the rating.

The one or more user interactions with the client comprise presenting content on the client.

Modifying the first data according to the interaction information comprises adding a data value to the data structure indicating a positive preference associated with a characteristic of the presented content.

The one or more user interactions with the client comprise skipping, deleting, pausing, stopping, or fast forwarding content on the client.

Modifying the first data according to the interaction information comprises adding a data value to the data structure indicating a negative preference associated with a characteristic of the skipped, deleted, paused, stopped, or fast forwarded content.

Modifying the first data according to the interaction information further includes incorporating changes to the first data based on a different version of the first data.

Incorporating changes to the first data based on the different version of the first data comprises replacing the first data with the different version of the first data.

Incorporating changes to the first data based on the different version of the first data comprises merging the first data with the different version of the first data.

The different version of the first data comprises a version of the first data received from a different client (e.g., a different device associated with the same user).

In another aspect, in general, the invention features a computer program, stored on a computer-readable medium, for communicating with a client over a network, the computer program comprising instructions for causing a computer system to: accept from the client first data arranged in a data structure that includes data values that correspond to preferences associated with a plurality of characteristics of content, and second data that includes interaction information that characterizes one or more user interactions with the client; modify the first data according to the interaction information; and provide to the client the modified data.

In another aspect, in general, the invention features a system for communicating with a client over a network, the system comprising: a content catalog storing information identifying content associated with content characteristics; a request module configured to accept from the client first data arranged in a data structure that includes data values that correspond to preferences associated with the content characteristics, and second data that includes interaction information that characterizes one or more user interactions with the client; and a processing module configured to modify the first data according to the interaction information.

Aspects of the invention can have one or more of the following advantages.

Providing a data structure that includes data values that correspond to preferences associated with content characteristics enables a content guide system to identify content that is relevant to a user. A user's content request can be processed according to any of multiple content characteristic preferences that may apply to the content request.

A client can send the data structure along with associated data that includes interaction information characterizing user, interactions with the client. The interaction information can be used to modify the data structure to incorporate explicit or implicit (e.g., inferred) information about the user's preferences. Providing the data structure to a guide server and returning the modified data structure to the user after the modification is made enables the user to maintain control of his own preferences, while allowing the content guide system to update his preferences based on stored information about semantic relevance relationships between content and/or other user's preferences.

In some implementations, an edge subsystem accepts and respond to requests from clients from a cache containing information from a main subsystem. The edge subsystem can provide increased response speed for a large number of content requests.

Other features and advantages of the invention will become apparent from the following description, and from the claims.

### DESCRIPTION OF DRAWINGS

FIG. 1 is a block diagram of a content guide system.

FIG. 2 is a block diagram of a guide server.

FIG. 3 is a diagram of a personal preference map data structure.

FIG. 4A-4C are flowcharts of preference map evolution processes.

### DESCRIPTION

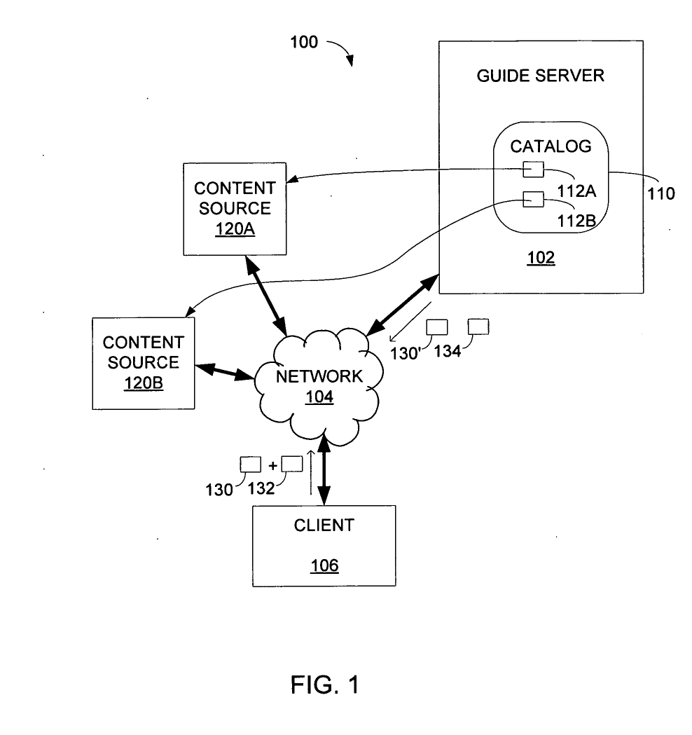

Referring to FIG. 1, a content guide system 100 includes a guide server 102 connected to a network 104. A client 106 is able to communicate with the guide server 102 over a communication channel provided by the communication capabilities of the client 106. For example, a computer may be able to communicate over a wired medium using a home access service provided by a service provider. A wireless device (e.g., a smart phone) may be able to communicate over a wireless link to a base transceiver station using a wireless service provided by a service provider. The network 104 provides communication infrastructure for passing communication among the client 106, the guide server 102 and various content sources (e.g., content sources 120A and 120B). The network 104 can include various types of public or private communication infrastructure including, for example, data networks (e.g., the Internet), or telephone networks (e.g., Public Switched Telephone Network).

The guide server 102 includes a content catalog 110 that stores information identifying content (e.g., links) and describing content (e.g., metadata) from various content sources connected to the network 104. The content catalog 110 does not necessarily store the content itself, but is able to catalog and track content based on stored content identifiers that can be used to retrieve the associated content. For example, the content identifier can be a Uniform Resource Locator (URL) or other information specifying the content source (e.g., a web server) and a data object containing the content. The guide server 102 recommends content to a user based on the user's content request and information in the content catalog 110.

A user is able to make a content request, for example, by explicitly entering a specific query or selecting an option from a list (e.g., News, Weather, Sports, Entertainment), or by implicitly indicating periodic requests to be submitted (e.g., request News every morning at 7 a.m.). The content request can represent desired content based on user interactions with the client 106. For example, if the user selects a “Present Latest World News” item on a user interface, the content request would include data specifying that world news is desired. In some cases, the content request includes other parameters further specifying the request.

The client 106 sends the user's content request along with a data structure called a personal preference map (PPM) 130 to the guide server 102. The PPM 130 includes data values that correspond to preferences associated with various characteristics of content. The data values in the PPM 130 can further specify the content request to help identify the most relevant content. The content characteristics represented in the PPM 130 correspond to content characteristics maintained in the content catalog 110. The PPM 130 can be configured to associate weights with preference data values to quantify a property (e.g., a level of interest or importance to the user) associated with the preference data values.

The guide server 102 uses the PPM 130 to customize a response that may include content identifiers, 112A and 112B, to recommended content from one or more content sources, 120A and 120B. For example, the guide server 102 is able to analyze relationships among the data values indicated in the PPM 130 to determine a set of one or more content identifiers 134 that identify content that may be of interest to the user. In some cases, the guide server 102 selects content identifiers from the content catalog 110 based directly on a content request from the client; and in some cases, the guide server 102 selects content identifiers having associated content descriptions related to other selected content. Thus, the content associated with each of the content identifiers can correspond to the content request, for example, by directly matching a content request (e.g., for “News”) to links in the content catalog 110 (e.g., links to latest world news), or by implicitly matching the content request to links in the content catalog 110 that have a preferred characteristic as indicated by the PPM 130 and are related to other selected content by a content relationship discovered by the guide server 102. For example, content about a particular hobby may not directly correspond to a request for “News,” but may correspond to a value in the PPM 130 and may correspond to a relationship discovered by the guide server 102 between a selected news content item and the content about the hobby. If the content request indicates a specific category or criteria for the type of content requested, the guide server 102 identifies content related to the requested category or satisfying the provided criteria.

The guide server 102 can associate a confidence level with each content identifier indicating a quality of the identified content according to confidence metric. For example, a confidence level can be a real number between −1 and +1. A positive number may indicate that the content is considered highly relevant to the request, and a negative number may indicate that the content is considered less relevant to the content request.

The guide server 102 is also able to modify (or “evolve”) the PPM 130 to update the user's preferences based on past user interactions with the client 106. In some cases, the guide server 102 updates the PPM 130 when a content request is being made; and in some cases, the guide server 102 updates the PPM 130 sent from the client 106 without a content request (e.g., at regular update intervals). The client 106 sends the PPM 130 to the guide server 102 along with auxiliary information 132. The auxiliary information 132 includes interaction information that characterizes one or more past user interactions with the client (e.g., characterizing which content identifiers the user selected or skipped). If a content request is being made, the auxiliary information 132 also includes the content request (e.g., a query or a selected content category or a selected type of content). The auxiliary information 132 can also include information such as device characteristics of the client (e.g., a list of playable media types, loaded CODECs, screen resolution, available storage space, etc.), current time, current location (e.g., GPS position as latitude and longitude, or zip code), a number of content identifiers 134 to return (e.g., a minimum and/or maximum number), or a minimum confidence level to be associated with the returned content identifiers 134.

In response to receiving the PPM 130 and auxiliary information 132, the guide server 102 determines whether the PPM 130 should be updated, and if so, returns an updated PPM 130′ back to the client 106. If the auxiliary information 132 includes a content request, the guide server 102 also returns the content identifiers 134. The updated PPM 130′ is modified according to the interaction information to reflect preferences that may be inferred from associated user interactions. For example, if the user selected a first content identifier and skipped a second content identifier, the guide server 102 may add a value indicating a positive preference for a characteristic associated with the first content identifier and a value indicating a negative preference for a characteristic associated with the second content identifier. Some inferences may have a higher confidence level than other inferences. For example, a preference modification determined from a user interaction assigning a rating to a content object may have a higher confidence level than a preference modification inferred from user behavior. The guide server 102 can indicate the level of confidence associated with the modifications made, and can allow the user to accept or reject some or all of the modifications. For example, the user can set a rule that the client should only accept an updated PPM 130 with a confidence level above a minimum value.

The communication between the client 106 and the guide server 102 can be implemented according to a transport independent communication protocol. The protocol defines a set of requests and corresponding responses in a manner that is not bound to any particular communications medium. In some implementations, the protocol provides a mechanism for the guide server 102 to identify a user and/or a client device, for example, for purposes of authorization. An authorized user or device may have access to particular subscribed services. In some implementations, the protocol provides a mechanism for anonymous service without necessarily being able to identify the user or client device. The PPM 130 can be configured to provide preference data values without including any information that identifies a particular user to a high degree of certainty.

The guide server 102 includes processing modules that catalog available content and maintain information that can be used to identify high quality and relevant content for a given client. The processing modules of the guide server 102 can run in one or more computer systems, and can be provided as one or more computer programs on a computer-readable medium. In some implementations, the guide server 102 includes distributed subsystems to provide additional services or to provide performance enhancement. For example, an edge subsystem can accept and respond to requests from clients from a cache containing information from the content catalog 110. If the edge subsystem is not able to respond to the request based on cached information, the edge subsystem can pass the request along to a main system of the guide server 102.

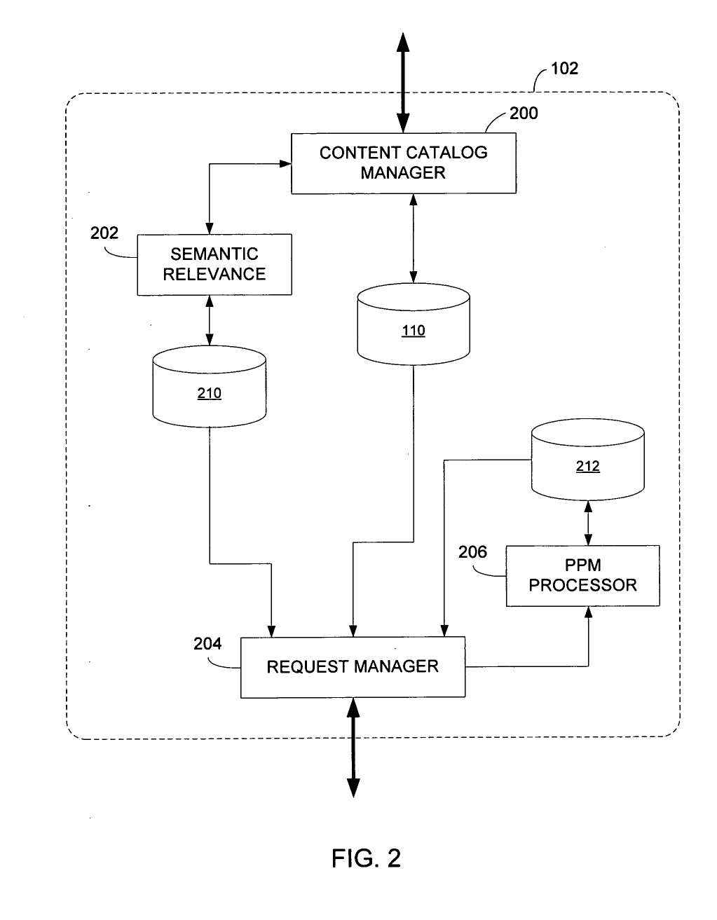

Referring to FIG. 2, an exemplary implementation of the guide server 102 includes a content catalog manager (CCM) module 200, a semantic relevance (SR) module 202, a request manger (RM) module 204, and a PPM processor (PP) module 206. The CCM module 200 monitors content sources in the network 104 to maintain up-to-date information in the content catalog 110. The CCM module 200 also determines what information is to be provided to the SR module 202, which maintains a relevant content matrix (RCM) 210. The RM module 204 responds to content requests using information from the content catalog 110 and the RCM 210, and sends PPMs to the PP module 206 for updating. The PP module 206 also maintains a PPM database 212 of copies of individual PPMs and aggregate PPMs that are generated from multiple individual PPMs. The PPMs in the PPM database 212 can be used to derive statistical information associated with PPMs without necessarily being linked to or otherwise identifying personal information associated with the users who submitted the PPMs. For example, in some implementations, any personally identifiable information in the PPM is encrypted and can only be accessed with permission from the user.

The CCM module 200 identifies and retrieves information about potential content that may be available from content sources in the network 104. The content sources can provide various types of content including, for example: audio files, video files, RSS feeds, Blogs, Podcasts, or various other types of structured data such as XML or HTML content. Content sources can be searched using, for example, a web crawler or web robot. Some content sources may provide publicly available content, and some content sources may provide content available according to a license agreement. If the information retrieved by the CCM module 200 identifies or describes a content object that is available from a content source, the CCM module 200 can configure the information for storage in the content catalog 110. The CCM module 200 stores a content identifier (e.g., a URL) for each content object, and associates metadata (e.g., in XML form) with the identifier to describe characteristics of the content object. Over time, the CCM module 200 updates or removes content identifiers to prevent invalid links, for example.

The CCM module 200 can automatically discover potential sources of useful information about available content, or can accept a list of identified information sources from a guide server operator. For example, information sources such as RSS feeds (e.g., news and blog feeds) and other publicly available sources (e.g., wikipedia.org, musicmoz.org, freedb.org, etc.) or proprietary/licensed sources can be included in the list.

The information sources can also provide information that can be used by the guide server 102 to discover relevance associations among different types of content. The CCM module 200 can pass retrieved information to the SR module 202 to be parsed for semantic meaning and used to identify relevance associations among content objects identified in the content catalog 110. For example, the SR module 202 can use one or more ontologies (e.g., as used in various artificial intelligence techniques, or projects such as the semantic web) to represent knowledge about relevance (or other type of relationship) of one category of content to another category (or subcategory) of content.

The SR module 202 stores the discovered relevance associations in the RCM 210. The RCM 210 can be implemented as a database storing associations among content objects having content identifiers within the content catalog 110. Each association can include information indicating the relative strength of the connection. The SR module 202 updates discovered associations to maintain relevance as changes occur (e.g., changes in consumer interests, changes in available content sources, etc.).

The RM module 204 receives content requests and determines what content identified in the content catalog 110 may be relevant to the request based on the user's PPM 130 and the RCM 210. The RM module 204 includes a plug-in mechanism to allow users or content or portal providers, for example, to customize or extend functionality of the RM module 204. Sub-modules installed using the plug-in mechanism can select relevant content identifiers from the content catalog 110 based on the user's content request and PPM 130 according to predetermined criteria.

If a user submits a content request without a PPM 130, the RM module 204 may determine (e.g., based on the auxiliary information 132) that the user has not yet been assigned a PPM 130 (in some cases a user may choose not to submit his PPM 130 with his content request). The RM module 204 can assign a PPM 130 to the user from a baseline preference map (BPM). The PP module 206 maintains one or more BPMs as default PPMs determined by operators of the guide server 102, or determined based on statistics collected from PPMs stored in the PPM database 212.

For example, the PP module 206 can generate an aggregate PPM representing generalized aggregate preferences of multiple PPMs. The PP module 206 can aggregate preferences across a large set of PPMs representing a statistically significant segment of the population. The aggregate PPMs can be used to form archetypal baseline preference maps indicating specific “galaxies of interest”. For example, the PP module 206 can generate archetypal baseline preference maps to represent interests of segments of the population or trends associated with content preferences. The PP module 206 periodically reviews the BPMs to assess their relevance as starting-points and adjusts them as appropriate.

The PP module 206 updates a PPM 130 received by the RM module 204 if the auxiliary information 132 indicates that updating should occur. The auxiliary information 132 can include directives for how to update the PPM 130 (e.g., aggressive updating, or conservative updating). The PP module 206 is able to use multiple PPMs for updating. For example, the PP module 206 can update one PPM 130 based on one or more other PPMs or BPMs (e.g., from friends, influential or popular people, or an archetypal BPM).

When updating a PPM 130, the PP module 206 determines how heavily to weight different user interactions represented by the interaction information included in the auxiliary information 132. The interaction information includes a list of user interactions that have occurred since the last update of the PPM 130. The user interactions can include rating content, skipping content, replaying content, fast-forwarding content, etc. The PP module 206 assigns a “generation number” to identify each version of the PPM 130 as it evolves over multiple updates. A confidence level associated with the updated PPM 130 indicates to what extent the modifications made were due to interactions explicitly indicating user preferences (e.g., content ratings) as opposed to inferences about user preferences from interactions by the user with selected content (e.g., skipping content, replaying content, fast-forwarding content, etc.). The interaction information can also include characteristics associated with the interactions such as the mood of the user, the local time, and location of the device.

If the standard configuration for the data structure of a PPM 130 has changed since the last update, the PP module 206 can also convert the PPM data structure to the new configuration, while preserving the preferences. The PP module 206 includes a plug-in mechanism to allow users or content or portal providers, for example, to customize or extend functionality of the PP module 206.

The output of the RM module 204 includes a set of one or more content identifiers 134 identifying content that can be presented on the requesting client 106. In some cases, if the RM 204 fails to identify content meeting specified criteria or confidence level, the RM module 204 may not return any content identifiers. For example, a status response can indicate “success” or “failure” in fulfilling a content request. A failure may trigger subsequent action if appropriate (e.g. running other plug-in sub-modules). Based on the content identifiers 134, the client 106 can retrieve and present the content on the client's screen, speakers, or other output equipment (e.g., playing audio or video content, or presenting a web page or feed). In some implementations, the use of various plug-in sub-modules or the RCM 210 to refine the output of the RM module 204 may be limited to a subset of registered or licensed subscribers, for example.

Some content identified within in the content catalog 110 may require access management based on identified rights. Licensed users are able to connect to a Digital Rights Manager (DRM) that monitors and controls access to the licensed content, for example, according to a subscription model.

The guide server 102 enables a user to access his own PPM 130 and settings on client device(s). The user can access and modify his own PPM 130, for example, by connecting a client device on which the PPM 130 is stored to a secure web site. The user can view and alter PPM attributes. The user can save the state of the PPM 130 and revert to past saved PPM states. The user can associate multiple client devices to one or more PPMs (e.g. for co-evolution, merging, influencing, etc. of the PPMs).

The communication protocol includes a mechanism for a user to optionally specify a preferred method (e.g., a plug-in sub-module) for various heuristic functions (e.g., content selection, PPM updating) if multiple such methods are available. In some cases, a user can specify that a different RM plug-in module should be used to satisfy a content request. For example, a user can specify use of a plug-in sub-module for the RM module 204 that matches a content request with popular and/or highly-rated content based on the RCM 210 and a representative aggregate PPM from the PPM database 212. A user can “borrow” or “trying out” PPMs from others (e.g., from friends, influencers, celebrities, etc.).

In some implementations, the RM module 204 is able to identify content based on two or more PPMs. For example, if two users are sitting next to each other in front of a client device, the device may detect their respective PPMs (e.g., being broadcast via Bluetooth from personal devices) and use both PPMs to make a content request.

Plug-in sub-modules for various modules (e.g., CCM, RM, PP) can be called simultaneously, in sequence, and/or using the output of one as input to the other.

A feedback mechanism provides a way for users (e.g. client device users, system managers, content experts, content producers, etc.) to contribute content information for the content catalog 110 or relevance information for the RCM 210.

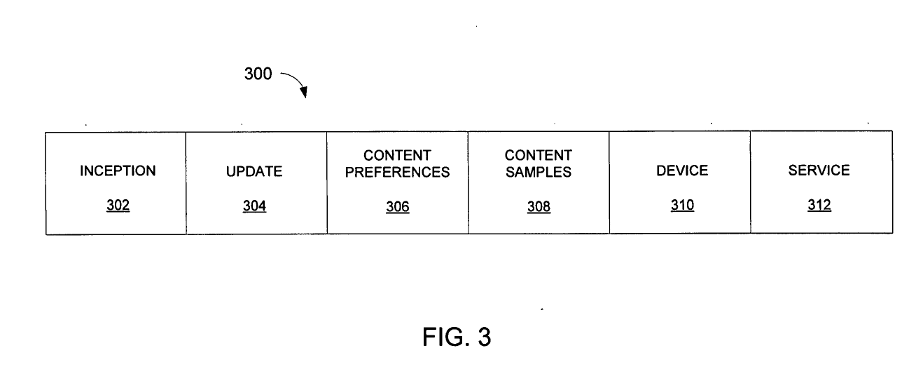

FIG. 3 shows an exemplary PPM or BPM data structure 300. The data structure 300 can be formatted according to a standardized format or markup language (e.g., XML). The data structure 300 includes sections that have data values representing information associated with a user's content preferences.

An inception section 302 includes data values corresponding to information about the inception of a given PPM. Data values include a unique identification string common to different versions of a user's PPM, an inception date, and the identification string of a “parent” BPM from which the PPM was generated on that date. If the PPM was not generated from one or more other BPMs or PPMs (e.g., the data structure corresponds to a BPM) then no parent is identified. If the PPM was generated by merging two or more BPMs and/or PPMs, then multiple parent identification strings can be included.

While the identification string of the PPM provides a unique identifying indicator, the identification string does not represent personally identifiable information to the general public.

An update section 304 includes data values corresponding to information about updates to a given PPM. A status value reports the version of the PPM's data structure. Other values include the number of updates experienced since inception, the timestamp of the last update, and any update preferences that specify how the PPM should be updated. For example, the update section 304 can include an “aggressiveness” parameter that indicates whether changes should be relatively conservative or aggressive. The update section 304 can include an “influence” parameter that indicates the weight given to other preference maps designated as influencers on PPM updates relative to other inputs (e.g., user behavior). The update section 304 can include a “lock” parameter enables the PPM to be locked with respect to updates (e.g., permitting the PPM to be read but not written). The lock parameter can indicate the extent to which the PPM may or may not be updated. For example, in one lock state updates to the values in the PPM are not allowed, but the PPM may be converted it to an updated data structure (e.g., according to an updated XML schema).

A content preferences section 306 includes zero or more data values corresponding to preferences associated with content characteristics. For example, a content preference specifies a content characteristic (e.g., genre, popularity, age, and tempo), a positive or negative preference index that characterizes a user's preference for the content characteristic, and optional modifiers (e.g. mood or time of day) to which the preference applies. Some content preferences are “canonical preferences” that are structured according to a uniform structure configured to apply to a variety of general content characteristics. Some content preferences are “freeform preferences” that have a structure that is able to be customized more specifically according to particular content characteristics, such as particular media types and/or particular content sources.

Some content preferences refer to specific types of media that can be associated with a device. A “media preference” specifies a media type (e.g., music, news feeds, and movies), a positive or negative preference index that characterizes a user's preference for the media type, and optional modifiers (e.g. time of day) to which the preference applies.

Content preferences can refer to other identified individual PPMs or archetypal BPMs that include a group of preferences derived from multiple PPMs. An archetypal BPM is identified by a unique ID and an associated positive or negative preference index indicates a positive or negative bias toward particular interests represented by the archetypal BPM.

A content samples section 308 includes zero or more data values corresponding to samples of content. For example, the data values include the an identification string corresponding to an item in the content catalog 110, an indicator of whether the item is generally representative or an anomaly, an indicator of whether the sample should be treated as stable or volatile with respect to PPM updates, a positive or negative preference index that characterizes a user's preference for the sample, and optional modifiers (e.g. mood) to which the preference applies. A volatile sample, for example, may include representative content that a user allows to be removed or replaced according to popular culture trends. A stable sample, for example, may include content that a user does not want to be removed or replaced (e.g., to represent long-term likes or dislikes). An anomalous sample, for example, may include content that do not necessarily reflect general preferences (e.g., the one and only country music song the user likes) and should not be used to influence PPM updates.

A device section 310 includes zero or more sub-sections having data values corresponding to client devices on which the PPM may be stored. For example, each sub-section can include data values indicating a device type and manufacturer, loaded software (e.g. CODECs), proprietary device information if any, and zero or more media preferences related to the device. Some of the information associated with a device can be static information that does not change with time, and some information can be dynamic information that may change with time, such as an associated location. The device section 310 can indicate whether a device is private or public, and whether the device can be shared by multiple users. The RM module 204 can match device characteristics included in the auxiliary information 132 with device characteristics in the device section 310 to determine the user's preferences for content to be identified for a particular type of device. The device section 310 can include device-specific preferences as well as device preferences that are not necessarily related only to a specific device, but may relate to multiple devices (e.g., a preferred volume level or screen brightness).

A service section 312 includes zero or more sub-sections having data values corresponding to services to which the user is subscribed. For example, each sub-section includes data values indicating a service provider, proprietary service information if any, and zero or more content preferences and/or media preferences specific to the service. The proprietary service information can include, for example, information associated with Digital Rights Management (DRM) to enable authorized access to certain content.

Different versions of a user's PPM 130 may not include the same data values or sections. For example, a PPM 130 resident on a given device need not carry device information for other devices (e.g., to save storage space).

In some implementations, the preference index values (e.g., real numbers between −1 and +1) characterizing preferences for content characteristics, content samples, and/or media types are multiplied by respective weighting factors that indicate a relative importance of different preferences to a user. The weighting factors (e.g., real numbers between 0 and 1) enable a user to indicate preferences for different content characteristics independently from how important the content characteristics are relative to one another, for example.

A PPM data structure 300 may include encrypted sections, or be encrypted in its entirety. There may be times when the PPM 130 may be transmitted in the clear (e.g., anonymous mode), while at other times parts may be encrypted (e.g., subscribed service mode), or the entire PPM 130 may be encrypted (e.g., private mode).

In a default mode (e.g., anonymous mode), the PPM 130 may not include any personally identifiable information (PII). In an enhanced mode (e.g., subscribed service mode), the PPM 130 may include an encrypted link to a location at which PII (e.g., name, email address, etc.) is stored.

### PROTOCOL EXAMPLE

Various aspects of an exemplary guide server communication protocol (called “Guide Protocol”) for interacting with the guide server 102 is described below.

The Guide Protocol defines a format for messages transmitted to and from the guide server 102 and for inputs and outputs associated with the messages. A message in the form of a procedure call or a document, for example, can specify a request and optional input arguments, and an output is returned in a response message. The messaging format can use any of a variety of architectural patterns for communicating over a protocol such as HTTP such as, for example, the Service-Oriented architectural pattern (SOAP), maintained by the W3C XML Protocol Working Group.

Two different types of messaging patterns within the SOAP framework are the Remote Procedure Call (RPC) style pattern, and the document style pattern. In the RPC style, explicit operations are defined, each with zero or more explicit input arguments and an output parameter. In the document style, explicit operations and input arguments are replaced with an XML document message, and the output response is an XML document. For example, a Web Services Description Language (WSDL) XML format can be used to provide an interface specification for the document style pattern. The RPC style facilitates an explicit mapping of operations to server-side functional handlers, reducing the logic required to determine appropriate functional actions. The document style provides a message-oriented approach for exchanging messages, in this case XML documents, as inputs and outputs. The document style also enables input arguments and output responses to be arbitrarily complex. A change in the internal schema of an input or output document does not necessarily change the corresponding WSDL interface specification.

The Guide Protocol can use a hybrid messaging pattern in which explicit operations are defined, but most input arguments and output responses are provided as XML documents. Some input arguments, such as an identification string and an authorization token, can be passed as separate data items not embedded in the input document to provide a performance advantage to processing actions that may not need to parse all of the input document (e.g., processing performed by an edge subsystem cache). This hybrid approach combines the advantages of explicit function mapping while preserving the flexibility of input arguments and output responses.

The Guide Protocol can perform operations in any of a variety of communication styles including: synchronous, asynchronous, and non-synchronous. In the synchronous style, the client 106 submits an input document to the guide server 102, waits for the guide server to process the request, and receives the output response document returned from the guide server in a synchronous exchange.

The asynchronous style enables the submission of an input document to be disconnected from server-side processing. An initiating call from the client 106 submits an input document to the guide server 102 for the specific operation and returns after receiving a unique receipt output document from the guide server 102. The guide server 102 then proceeds to process the request in a separate thread eventually storing the results awaiting pickup. In a polling scheme, the caller then makes closing calls using the receipt to request the results from the guide server 102 until the results are ready. If the results are not yet ready, the closing call returns. Alternatively, the guide server 102 can notify the caller at the client that the results are ready.

The non-synchronous style is used when no results are expected or required. In this style, the client 106 submits an input document to the guide server 102 and receives a status output document, but does not need to wait for results. The output document indicates whether or not the operation was accepted and/or authorized for processing.

The Guide Protocol provides a mechanism for authorizing a user to access some operations, but not others. The mechanism partitions operations into “zones” that signify user privilege. Zones can be ordered by privilege level such that assignment of a user to one zone implies assignment of the user to zones of lesser privilege. Thus, a user is authorized to access all Guide Protocol operations in their assigned zone and in all zones of lesser privilege.

The operations supported by the Guide Protocol are listed below partitioned into corresponding authorization zones. The zones, from least privileged to most privileged, are: Guest, Registered, and Premium.

The Guest zone operations are available to unregistered users. These operations provide basic capabilities to use the services provided by the guide server 102 including the ability to become registered users. Guest zone operations include the following.

Register a Device: This operation registers a new client device and optionally generates a baseline preference map to be stored on the device as an initial PPM. A device ID is associated with the registered device and is stored within the content guide system 100 such that it is accessible to the guide server 102. If a given device is already registered when the operation is performed, the device can be reset (e.g., any association with a registered user is removed). Information that can be used to help guide selection of an appropriate BPM to be used as the initial PPM can be derived, at least in part, from answers from a survey given to a user during device registration. One of the questions can explicitly ask the user to specify or select a desired BPM (e.g., an archetypal BPM) to be used as the initial PPM. Optionally, a user can specify that an initial preference map should not be downloaded upon device registration.

Reset a Device: This operation returns the device to its newly registered state. The device retains its device ID, but obtains a new baseline preference map. This operation also removes all links to registered users.

Unregister a Device: This operation deletes a device ID from the content guide system 100. This operation can be used, for example, to discontinue the use of services of content guide system 100 with the device.

Register a User: This operation registers a new user in association with a client device and returns an authorization token for Registered zone access. The authorization token can include an expiration date. The device to be associated with the user should be registered prior to this operation being performed. A user ID is associated with the user and is stored within the content guide system 100 such that it is accessible to the guide server 102. A password can also be established (e.g., using a secure protocol) to authenticate the user. If the user is new to the content guide system 100, the local PPM stored on the device is registered with the content guide system in association with the user ID (e.g., a copy of the PPM is stored in the PPM database 212). If the user has previously been registered with the content guide system 100 in association with a different client device and/or PPM, various options determine how the local PPM stored on the device and previously registered PPMs are reconciled.

Check Authorization: This operation checks the validity and currency of an authorization token. If the authorization token is valid, but expired, a new authorization token can be generated and returned.

Select Content: This operation requests content identifiers from the content catalog 110 based on one or more PPMs and various other query parameters.

The Registered zone operations are only available to registered users. They provide additional services available from the content guide system 100. Registered users also have access to all Guest zone operations. Registered zone operations include the following.

Unregister a User: This operation is used to unregister a user. Arguments can be provided with this operation, for example, to determine whether the operation will fully remove the user from the content guide system 100, or will remove the user's association to the device from which the operation is invoked, while allowing the user to remain associated with other devices.

Evolve Preferences: This operation processes recent behavior represented by the interaction information included in the auxiliary information 132 to create an evolved version of the PPM. The new PPM is returned to the client, and can optionally be saved in the PPM database 212.

List Previous Preferences: This operation requests a list of previous PPM versions that can be retrieved, for example, according to an identification string and a timestamp indicating when the version of the PPM was updated. Retrieval of this list can be used, for example, to reinstate a previous PPM version as the current PPM.

Reinstate Preferences: Used in conjunction with List Previous Preferences, this operation enables a rollback to a previous version (or “evolution state”) of a PPM. This is can be used, for example, when a user has reason to believe that recent behavior is uncharacteristic and they do not wish to wait while “natural evolution” corrects the deviation.

Download Preferences: This operation enables a PPM to be downloaded from the PPM database 212 either in its entirety or just those portions that are relevant to the calling device type. Variants of this operation (e.g., using different arguments) can be used, for example, to download: the current PPM, a specific previous version of a PPM, or another user's PPM given permission of that user (e.g., with valid cross-authorization credentials).

Upload Preferences: This operation uploads a PPM to the PPM database 212 and reconciles differences using a variety of options. These options can include: replace with the uploaded PPM, retain the greater (or most recently) evolved PPM, retain the lesser (or least recently) evolved PPM, or merge the PPMs.

Merge Preferences: This operation is a utility that merges two or more PPMs into a single PPM. This operation may be used, for example, for shared devices such as a home video device for which content selection may need to be performed to the satisfaction of multiple users.

The Premium zone operations are available to Registered users who have obtained Premium zone status (e.g., through a paid subscription). Premium zone users have access to all of the capabilities defined in the Guide Protocol including those of the Guest and Registered zones. Premium zone operations include the following.

Select Content: This operation requests content identifiers from the content catalog 110 based on one or more PPMs and various other query parameters. This operation is distinguished from its Guest zone counterpart in that this operation can be processed according to plug-in sub-modules that are not available to the Guest zone operation.

Execute a Service: This operation enables the calling of an arbitrary service and optionally a specific plug-in sub-module associated with the service. This operation and the corresponding services enable server-side functionality to be extended.

In addition to operations that may be explicitly initiated by a user, the Guide Protocol supports operations for maintaining synchronization among multiple devices that may be associated with a user. For example, if a user initiates an operation from a client device to the guide server 102, the guide server may perform an additional synchronization operation to update the device according to a different version of the PPM uploaded from a different device (e.g., a PPM with the same identification string but a different timestamp for a previous update). An explicit synchronization operation can also be provided (e.g., as a Guest operation) to enable the user to explicitly force synchronization of a device to update the device according to a version of the PPM uploaded from a different device. The user can determine how the PPM stored on the device is to be updated according to a previously uploaded version of the PPM. For example, the stored PPM can be replaced with the uploaded version (e.g., if the uploaded version is more recently changed), or the stored PPM and uploaded version can be merged in a predetermined way (e.g., forming a union of data values by combining data values for the respective sections and discarding duplicate data values). The updated PPM can also be modified based on recent behavior represented by the interaction information included in the auxiliary information 132.

### PPM EVOLUTION EXAMPLE

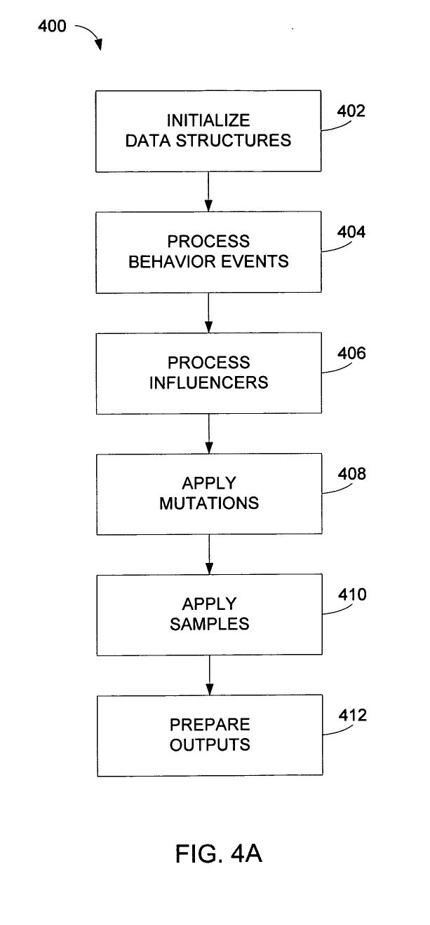

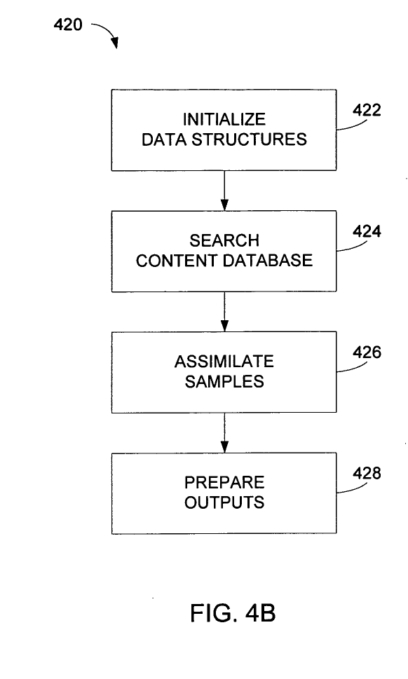

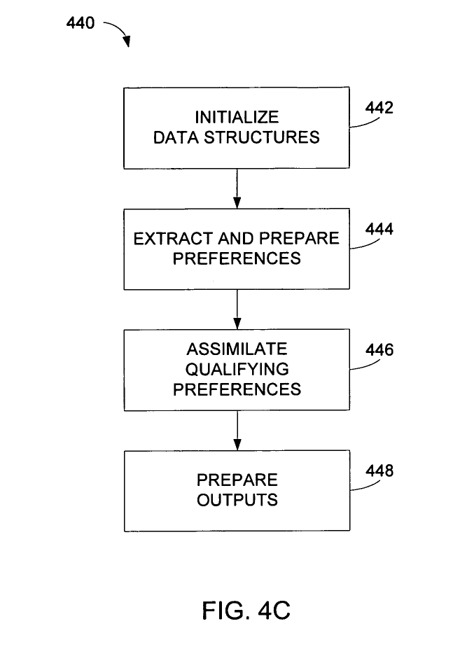

FIG. 4A shows a flowchart for an exemplary PPM Evolution process 400 that can be performed by the PP module 206 to modify or “evolve” an input PPM to an updated PPM, as described below.

Inputs to the process 400 include the following.

ppmCurrent: a PPM to be evolved from its current state. A preference P in the PPM corresponds to a tuple (P.p, P.s), where a preference identifier P.p represents a given content characteristic, and a preference strength P.s is a preference index value for the content characteristic.

aggressiveness: a control parameter in the range 0.0 to 1.0 that determines the rate of evolution.

behavior[ . . . ]: an array of user interactions (or “behavior events”) occurring since the last time PPM was evolved. Each behavior event B indicates user interactions with respect to an identified content item.

ipm[ . . . ]: an array of influencing PPMs or BPMs.

gravity[ . . . ]: an array of weights g in the range −1.0 to 1.0 that indicate the influence exerted by corresponding ipm array preference maps. A gravity of g=0 has the same influence on evolution as behavior events in behavior.

Outputs of the process 400 include the following.

ppm: the PPM in its evolved state.

confidence: a parameter in the range −1.0 to 1.0 that reports the confidence in interpreting behavior events.

The PP module 206 begins by initializing 402 data structures to be used in evolving the PPM. The data structures that are initialized include the following.

mutation[ . . . ]: this data structure is initialized as an empty list of mutations. An entry M added to this list during the process 400 is in the form of a tuple (M.p, M.s) where M.p is a preference identifier and M.s is the corresponding strength.

sample[ . . . ]: this data structure is initialized as an empty list of sample content items. An entry S added to this list during the process 400 is in the form of a tuple (S.c, S.s), where S.c is a content item identifier and S.s is the corresponding strength.

conf[ . . . ]: this data structure is initialized as an empty array of confidence values.

ppm: this data structure is initialized by copying ppmCurrent and incrementing the generation number in ppm.

The PP module 206 processes 404 behavior events B from the array behavior[ . . . ]. For each behavior event B, the PP module 206 performs the following:
Based on the characteristics of B (e.g., no skip, skipping some percentage of the item, actively rating the item, etc.), the PP module 206 determines a preference factor f in the range −1.0 (e.g., extreme dislike) to +1.0 (e.g., extreme like).
The PP module 206 determines confidence in deriving f from B to yield a confidence value in the range −1.0 (e.g., guess) to +1.0 (e.g., certainty). The PP module 206 inserts this confidence value as a new entry into conf [ . . . ].
The PP module 206 determines an array X[ . . . ] of attributes related to the content item identified in B. Each attribute A in the array X[ . . . ] corresponds to a tuple (A.p, A.w) where A.p is a preference identifier and A.w is a corresponding weight.
For each attribute A in X[ . . . ], the PP module 206 generates a mutation tuple (M.p, M.s), where M.p=A.p and M.s=A.w·f, and insert the tuple as a new entry into mutation [ . . . ].
If B indicates an active rating by the user (e.g., “never” or “always”), the PP module 206 adds a new entry (S.c, S.s) into sample [ . . . ], where S.c is the content item identified in B and S.s indicates the active rating (e.g., −1.0 or +1.0 for “never” or “always”, respectively).

The PP module 206 processes 406 influencers I from the array ipm[ . . . ]. For each influencer I, the PP module 206 performs the following:
The PP module 206 determines a weight g from the gravity[ . . . ] entry corresponding to the influencer I.
The PP module 206 derives from I an array X[ . . . ] of prominent (e.g., highly positive or negative) attributes. Each attribute A in the array X[ . . . ] corresponds to a tuple (A.p, A.w) where A.p is a preference identifier and A.w is a corresponding weight.
For each attribute A in X[ . . . ], the PP module 206 generates a mutation tuple (M.p, M.s), where M.p=A.p and M.s=A.w·g, and inserts the tuple as a new entry into mutation[. . . ].
The PP module 206 derives from I an array Y[ . . . ] of prominent (e.g., highly positive or negative) sample content items. Each sample content item S′ in the array Y[. . . ] corresponds to a tuple (S′.c, S′.s) where S′.c is a content item identifier and S′.s is the corresponding strength.
For each sample content item S′ in Y[ . . . ], the PP module 206 generates a sample tuple (S.c, S.s), where S.c=S′.c and S.s=S′.s·g, and inserts the tuple as a new entry into sample[ . . . ].

The PP module 206 applies 408 mutations by performing the following:

The PP module 206 reduces the mutation[ . . . ] list by combining entries with duplicate preference identifiers M.p, for example, by adding their corresponding strength values M.s.

For each mutation M in the list mutation[ . . . ], the PP module 206 performs the following:
Set M.s=M.s·aggressiveness.
If ppm contains a preference P such that P.p=M.p, then:

```
{
    Retrieve the corresponding preference strength P.s corresponding
    to that preference from the ppm.
    Set M.s = P.s + (M.s · Eₘₐₓ), where Eₘₐₓ is a global evolution
    constant that reflects the maximum amount of influence any
    evolution step is permitted to exert on a PPM.
    Update the preference P with M.
}
```

Otherwise, if ppm does not contain a preference P such that P.p=M.p, then insert M into ppm.
For each preference P in ppm, the PP module 206 determines whether |P.s|<Eₘᵢₙ, and if so removes P from ppm, where Eₘᵢₙ represents a minimum absolute value of preference strength P.s.

The PP module 206 applies 410 samples by performing the following:
The PP module 206 determines the maximum number N of volatile samples (sample content items that are able to be changed in a PPM evolution) that ppm can carry including those that it currently contains.
The PP module 206 adds the volatile samples from ppm into sample[ . . . ].
The PP module sorts sample[ . . . ] into descending order based on the absolute value of their strengths S.s.
Replace the current volatile samples in ppm with the first N elements in sample[ . . . ] that do not duplicate an existing stable sample in ppm.

The PP module 206 prepares 412 outputs by performing the following:
Store ppm in the PPM database 212.
Calculate confidence as the average of the values in conf[ . . . ].

### BPM EVOLUTION EXAMPLES

Some BPMs represent the aggregation of PPMs for a statistically significant segment of the user population. A BPM can be used as an initial PPM. Since a carefully selected BPM is statistically more likely to be “closer” to a real person's preferences than a “blank” PPM, convergence of a PPM to a given user's actual preferences can be accelerated by using a BPM as the initial PPM. The PP module 206 can also use BPMs for influencing PPM evolution, and the PP module 206 can maintain a set of BPMs that evolve with respect to broad popularity trends.

FIGS. 4B and 4C show flowcharts for two exemplary BPM Evolution processes 420 and 440, respectively, that can be performed by the PP module 206 to generate an evolved BPM, as described below.

In the first “content discovery” BPM Evolution process 420, the PP module 206 evolves the content samples section 308 of a BPM and not the content preferences section 306. This process 420 can be used, for example, to associate newly released content with stable sets of preferences.

Inputs to the process 420 include the following.

bpmCurrent: a BPM to be evolved from its current state.

aggressiveness: a control parameter in the range 0.0 to 1.0 that determines the rate of evolution.

content[ . . . ]: the content catalog 110 as a set of tuples (c, a₁, a₂, . . . ), where c identifies a content item and each aᵢ represents an attribute to which preferences in a PPM or BPM can be matched.

Outputs of the process 420 include the following.

bpm: the BPM in its evolved state.

confidence: a parameter in the range −1.0 to 1.0 that reports the confidence in interpreting behavior events.

The PP module 206 begins by initializing 422 data structures to be used in evolving the BPM. The data structures that are initialized include the following.

bpm: this data structure is initialized by copying bpmCurrent and removing any sample items from its content samples section 308.

sample[ . . . ]: this data structure is initialized as an empty list of content item samples. An entry added to this list during the process 420 is in the form of a tuple (S.c, S.s), where S.c is a sample content item identifier and S.s is the corresponding confidence strength.

The PP module 206 searches 424 content[ . . . ] for entries that are a close match (e.g., within a given tolerance) to the preferences defined in bpm and enters any matched content samples into sample[ . . . ]. This can be performed in cooperation with the CCM module 200. In some cases, emphasis is placed on achieving high confidence strength at the expense of a more exhaustive than typical analysis. The PP module 206 sorts sample[ . . . ] into descending order based on the absolute value of the confidence strengths S.s.

The PP module 206 assimilates 426 the samples by performing the following:
The PP module 206 determines the maximum number N of volatile samples that bpm can carry.
Starting with the highest confidence samples, the PP module insert entries from sample[ . . . ] into bpm until either N samples have been inserted or the confidence of the next available sample is less than C, where C represents a minimum confidence threshold for BPM samples.

The PP module 206 prepares 428 outputs by performing the following:
Store bpm in the PPM database 212.
Calculate confidence as the average of the selection confidence strength values S.s of those samples that were inserted into bpm.

In the second “segment modeling” BPM Evolution process 440, the PP module 206 generates a BPM whose content preferences section 306 is configured according to a group of PPMs selected to represent a statistically significant segment of the user population. This process 420 can be used, for example, to track the changing preferences of the users over time.

Inputs to the process 440 include the following.

ppms[ . . . ]: a set of PPMs selected as statistically representative of an archetypical user segment.

aggressiveness: a control parameter in the range 0.0 to 1.0 that determines the rate of evolution.

Outputs of the process 440 include the following.

bpm: the BPM in its evolved state.

confidence: a parameter in the range −1.0 to 1.0 that reports the confidence in interpreting behavior events.

The PP module 206 begins by initializing 442 data structures to be used in generating the BPM. The data structures that are initialized include the following.

bpm: this data structure is initialized as a neutral BPM.

pref[ . . . ]: This data structure is initialized as an empty array of preferences. An entry added to this list during the process 440 is in the form of a tuple (P.p, P.s, P.n), where P.p is a preference identifier, P.s is the corresponding scale factor, and P.n is the number of PPMs reporting this preference.

The PP module 206 extracts and prepares 444 preferences as follows. For each PPM in ppms[. . . ], the PP module 206 examines each preference X recorded in the PPM. For each preference X in the PPM, the PP module 206 locates an element corresponding to preference X in prefs[ . . . ]. If found, the PP module 206 denotes this element as preference P. Otherwise, the PP module 206 generates a new element in prefs[. . . ] denoted preference P with P.p=X.p and both P.s and P.n initialized to 0. The PP module 206 sets P.s=P.s+X.s and increments P.n.

The PP module 206 assimilates 446 qualifying preferences as follows. For each preference P in prefs[ . . . ], the PP module 206 determines whether P.n>N and |P.s|<Eₘᵢₙ, and if so, inserts P into bpm, where N is the minimum number of PPMs reporting a preference for that preference to be considered a viable baseline contributor and Eₘᵢₙ is a minimum preference strength.

The PP module 206 prepares 448 outputs by performing the following:
Store bpm in the PPM database 212.
Calculate confidence as the average of P.n values for the elements P in pref[ . . . ] normalized by a value S representing the largest number of PPMs expected to report the same preference. Since S is not a natural normalizer, out of range high values are clamped to S.

Other embodiments are within the scope of the following claims.

What is claimed is:

1. A method for communicating with a client over a network, the method comprising:
accepting from the client
first data arranged in a data structure that includes data values that correspond to preferences associated with a plurality of characteristics of content, and
second data that includes interaction information that characterizes one or more user interactions with the client;
modifying the first data according to the interaction information; and
providing to the client the modified data.

2. The method of claim 1, further comprising:
identifying content corresponding to at least one of the characteristics based on at least one of the data values; and
providing to the client a plurality of content identifiers, each identifying a location in the network of a portion of the identified content.

3. The method of claim 2, wherein the second data includes a content request.

4. The method of claim 3, wherein identifying content corresponding to at least one of the characteristics based on at least one of the data values comprises selecting content identifiers from a catalog of content based on at least one of the data values, where content associated with each of the content identifiers corresponds to the content request.

5. The method of claim 4, wherein selecting content identifiers from the catalog of content comprises selecting a first content identifier associated with a content description in the catalog that directly matches the content request, and corresponds to at least one of the data values

6. The method of claim 5, wherein selecting content identifiers from the catalog of content comprises selecting a second content identifier associated with a content description in the catalog that is related to the content description associated with the first content identifier, and corresponds to at least one of the data values.

7. The method of claim 2, wherein the second data includes information that indicates device characteristics of the client.

8. The method of claim 7, wherein identifying content further comprises matching the device characteristics included in the second data to device characteristics included in the first data.

9. The method of claim 1, wherein the first data further includes data values that correspond to preferences associated with one or more samples of content.

10. The method of claim 1, wherein the first data further includes data values that correspond to preferences associated with one or more media types.

11. The method of claim 1, wherein at least some of the data values are modified by respective weighting factors that indicate a relative importance of different preferences to a user.

12. The method of claim 1, wherein the interaction information comprises data characterizing one or more user interactions with the client associated with content retrieved according to content identifiers provided to the client before the first data was modified.

13. The method of claim 12, wherein the one or more user interactions with the client comprise rating content according to a characteristic.

14. The method of claim 13, wherein modifying the first data according to the interaction information comprises adding a data value to the data structure indicating a preference associated with the characteristic according to the rating.

15. The method of claim 12, wherein the one or more user interactions with the client comprise presenting content on the client.

16. The method of claim 15, wherein modifying the first data according to the interaction information comprises adding a data value to the data structure indicating a positive preference associated with a characteristic of the presented content.

17. The method of claim 12, wherein the one or more user interactions with the client comprise skipping, deleting, pausing, stopping, or fast forwarding content on the client.

18. The method of claim 17, wherein modifying the first data according to the interaction information comprises adding a data value to the data structure indicating a negative preference associated with a characteristic of the skipped, deleted, paused, stopped, or fast forwarded content.

19. The method of claim 1, wherein modifying the first data according to the interaction information further includes incorporating changes to the first data based on a different version of the first data.

20. The method of claim 19, wherein incorporating changes to the first data based on the different version of the first data comprises replacing the first data with the different version of the first data.

21. The method of claim 19, wherein incorporating changes to the first data based on the different version of the first data comprises merging the first data with the different version of the first data.

22. The method of claim 19, wherein the different version of the first data comprises a version of the first data received from a different client.

23. A computer program, stored on a computer-readable medium, for communicating with a client over a network, the computer program comprising instructions for causing a computer system to:
accept from the client
first data arranged in a data structure that includes data values that correspond to preferences associated with a plurality of characteristics of content, and
second data that includes interaction information that characterizes one or more user interactions with the client;
modify the first data according to the interaction information; and
provide to the client the modified data.

24. A system for communicating with a client over a network, the system comprising:
a content catalog storing information identifying content associated with content characteristics;
a request module configured to accept from the client
first data arranged in a data structure that includes data values that correspond to preferences associated with the content characteristics, and
second data that includes interaction information that characterizes one or more user interactions with the client; and
a processing module configured to modify the first data according to the interaction information.
